(19) United States
(12) Patent Application Publication
(10) Pub. No.: US 2011/0031234 A1
(43) Pub. Date: Feb. 10, 2011

(54) ELECTRIC GRILLING DEVICE WITH PARTIAL HIGH-TEMPERATURE HEATING FUNCTION

(75) Inventors: Hwaihsiang Kuo, Taiwan (CN); Qisheng Lai, Fujian (CN)

Correspondence Address: RABIN & Berdo, PC, 1101 14TH STREET, NW, SUITE 500, WASHINGTON, DC, 20005, US

(73) Assignee: TSANN KUEN(CHINA) ENTERPRISE CO., LTD, Xiamen, Fujian (CN)

(21) Appl. No.: 12/937,595

(22) PCT Filed: Apr. 17, 2009
(86) PCT No.: PCT/CN2009/071337

§ 371 Date: Oct. 13, 2010

(30) Foreign Application Priority Data
Apr. 17, 2008 (CN) 200820102024.8

(51) Int. Cl. H05B 3/68

(52) U.S. Cl. 219/450.1; 219/463.1; 219/468.2

(57) ABSTRACT

An electric grilling device with partial high-temperature heating function has an electric heating tube installed on the bottom of a grilling plate. The electric heating tube is bent into an intensive distribution structure shape and the bottom of the grilling plate has an embedding groove corresponding to the shape of the electric heating tube. The electric heating tube is installed in the embedding groove. The surface of the grilling plate corresponding to the intensive distribution structure of electric heating tube is defined as high-temperature region. This structure has a partial high-temperature function of the grilling plate and satisfies the different temperature requirements of grilling different food. The device utilizes the energy more efficiently to overcome the shortages of conventional electric grilling devices wherein temperature of the grilling plate is relative low. The structure of the device is simple and it is easy to operate.

### FIELD OF THE INVENTION

The present invention relates to a kitchen household appliance, especially relates to an electric grilling device with partial high-temperature heating function.

### BACKGROUND OF THE INVENTION

With the rapid progress of national economy and the great promotion of people's living standard, various household appliances with multiple functions are brought into our daily lives, thereby great conveniences are brought. For example, grilling device is one of the household appliances, especially the grilling device heated by electricity, it is clean, safe, convenient and rapid, so it is well-received by the consumers. The conventional electric grilling device usually comprises a grilling plate and an electric heating tube, the grilling plate is used for containing food and grilling the contained food, the electric heating tube is installed on the bottom of the grilling plate, when the electric heating tube is energized and heated, the heat will be transmitted and stored on the grilling plate, so the temperature of the grilling plate will be raised, thereby the food on the surface of the grilling plate will be grilled, one of the key features of the structure of the conventional electric grilling device is: in order to unify the heat of the grilling plate, the electric heating tube is bended into an equally-distributed shape and installed on the bottom of the grilling plate, a typical bending shape is by bending the tube body of the electric heating tube into a frame shape, when the electric heating tube is energized and heated, the equally-distributed electric heating tube will transmit the heat to the grilling plate, the thickness of the grilling plate is unified in order to equally transmit the heat, thus the temperature distribution of each portion of the surface of the whole grilling plate is unified, the food can be grilled uniformly. However, since people constantly has changing requirements for living quality, so various kinds of food are chose to be grilled, thereby the demands for the temperature of the grilling plate are different, because the temperature distribution of the conventional grilling plate is equal, so the temperature of the surface of the grilling plate is relatively low and the high-temperature region is lacked, so the conventional grilling device can not satisfy the requirements for grilling different food, the grilling effects are affected.

### SUMMARY OF THE INVENTION

The object of the present invention is to overcome the shortages of the conventional technique and provide an electric grilling device with partial high-temperature heating function, by improving the structure, the present electric grilling device can achieve a partial high-temperature function of the grilling device, thus the different temperature requirements of different foods are satisfied, the energy is fully and reasonably utilized, the unsatisfied grilling effects brought by the relatively low temperature of the conventional electric grilling plate is overcome, the structure of the present grilling device is simple, and it is convenient to be operated.

The technical solution applied by the present invention is: an electric grilling device with partial high-temperature heating function, comprising a grilling plate and an electric heating tube installed on the bottom of said grilling plate, wherein the electric heating tube is bended into a shape with at least one intensive distribution structure, the bottom of the grilling plate has an embedding groove corresponds to the bending shape of the electric heating tube, the electric heating tube is installed in the embedding groove correspondingly, the surface of said grilling plate where corresponds to the intensive distribution structure of said electric heating tube is defined as high-temperature region.

The high-temperature region of the surface of the grilling plate is disposed on a side portion of the surface of said grilling plate.

Said grilling plate where corresponds to said high-temperature region is a thickening structure.

The intensive distribution structure of said electric heating tube is a wave shape formed by the bending of said electric heating tube.

Said electric heating tube is bended into a frame shape, its intensive distribution structure is a protruding portion formed by the inward and integrative bending of one of frame edges.

The electric grilling device with partial high-temperature heating function of the present invention, it bends the electric heating tube into a shape with at least one intensive distribution structure, the surface of the grilling plate corresponding to the intensive distribution structure is inevitably the high-temperature region, it is because the electric heating tube is intensively distributed on that position, the electric heating tube will emit more heat after energized, more heat will be transmitted and stored on said region of the grilling plate compared to other regions of the grilling plate, so the temperature of said region of the grilling plate will be higher than other regions of the grilling plate. The shape of the intensive distribution structure of the electric heating tube can be various, a typical shape is wave shape, since the electric heating tube is bended into wave shape, so the tube bodies of the electric heating tubes are more closer to each other, and the distribution of the electric heating tube is intenser than other regions, certainly, other shapes can also be used. For a frequently-used frame shape which can realize equal distribution, a simple manner to form intensive distribution structure is by inward and integrative bending one of the frame edges into a protruding portion, so there will be four tube bodies of electric heating tube close to each other in said region, the electric heating tubes will be intensively distributed compared to other regions. The position of the intensive distribution structure of the electric heating tubes is depended on the position of the high-temperature region of the surface of the grilling plate, when the high-temperature region is needed to be disposed on a side end of the grilling plate, the intensive distribution structure of the electric heating tubes will be correspondingly disposed on said side end, and so forth. The intensive distribution structure of the electric heating tube can be disposed on one place or many places, when the grilling plate only needs one high-temperature region, the electric heating tube will be bended into a shape with one intensive distribution structure, when the grilling plate needs two high-temperature regions, the electric heating tube will be bended into a shape with two intensive distribution structures, and so forth.

The electric grilling device with partial high-temperature heating function of the present invention, it not only improves the structure of the electric heating tube, but also the grilling plate where corresponds to the high-temperature region is thickened, so the heating effect will be better, since the thickness of said position of the grilling plate is increased, so it will be helpful for storing heat on the grilling plate, the temperature of the surface of the grilling plate will be raised further more.

The beneficial effects of the present invention are, since the electric heating tube installed on the bottom of the grilling plate is bended into a shape with at least one intensive distribution structure, meanwhile the grilling plate where corresponds to the intensive distribution structure of the electric heating tube is thickened, so said region of the surface of the grilling plate will be a high-temperature region compared to other regions, the partial high-temperature heating function is realized, thus different food can be cooked with different grilling temperature, it overcomes the shortage of the conventional electric grilling device wherein the temperature of the grilling plate is relative low and so the grilling effect is affected, meanwhile, the structure of the grilling device is simple, and it is convenient to be operated.

The present invention will become apparent with the reference to the accompanying drawings and the embodiments; however the electric grilling device with partial high-temperature heating function of the present invention is not limited within the scope of the embodiment.

### BRIEF DESCRIPTION OF THE DRAWINGS

FIG. 1 is a structural view of the present invention;

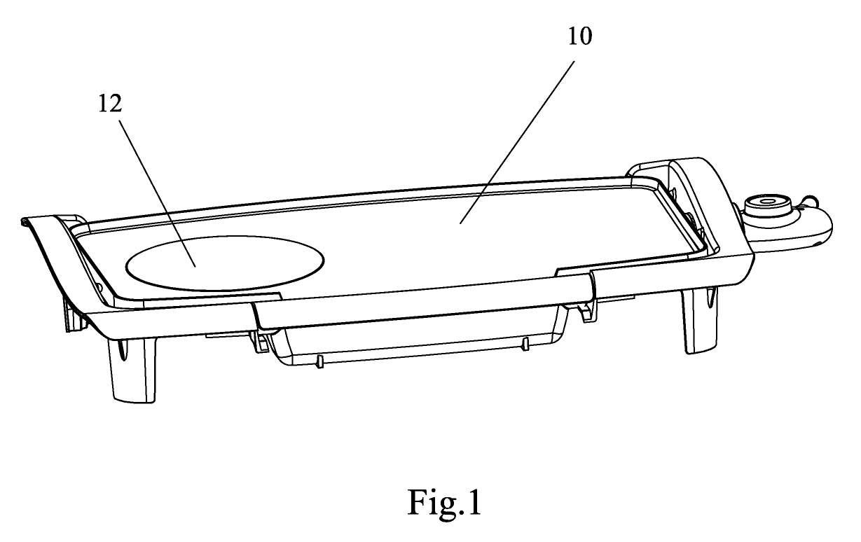

FIG. 2 is a structural view of the present invention wherein the bottom of the grilling plate faces upward.

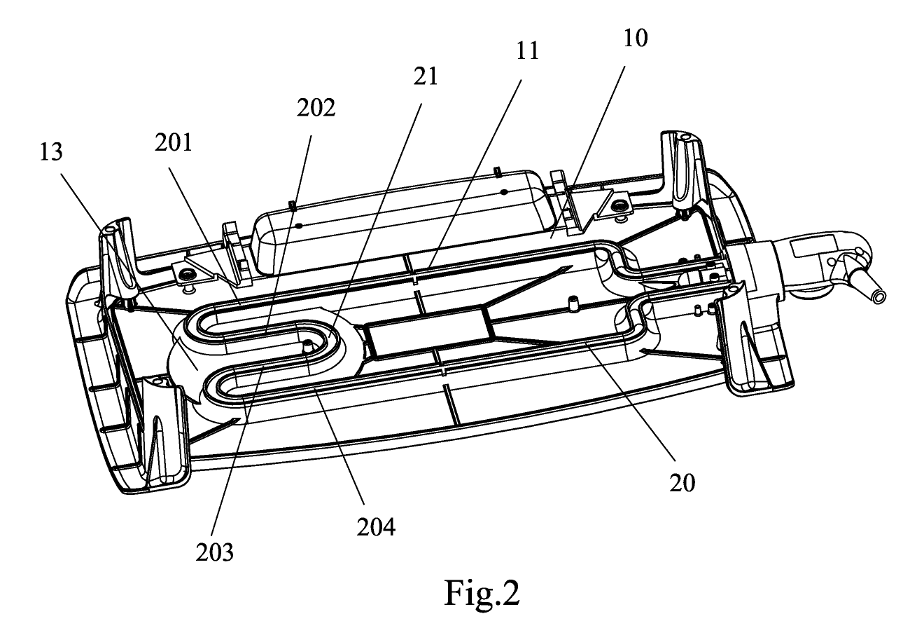

### DETAILED DESCRIPTION OF THE EMBODIMENTS

Please refer to the accompanying drawings, an electric grilling device with partial high-temperature heating function of the present invention, comprising a grilling plate 10 and an electric heating tube 20 installed on the bottom of the grilling plate 10; wherein, the electric heating tube 20 is bended into a shape with one intensive distribution structure, the bottom of the grilling plate 10 has an embedding groove 11 which corresponds to the bending shape of the electric heating tube, the electric heating tube 20 is correspondingly installed in the embedding groove 11 of the bottom of the grilling plate, the surface of the grilling plate 10 where corresponds to the intensive distribution structure of the electric heating tube is defined as high-temperature region 12.

Wherein:

The high-temperature region 12 of the surface of the grilling plate 10 is disposed on a side portion of the surface of the grilling plate;

The plate body of the grilling plate 10 where corresponds to the high-temperature region 12 is designed as a thickening structure 13.

The electric heating tube 20 is bended into a frame shape, its intensive distribution structure is a protruding portion 21 formed by the inward and integrative bending of one of the frame edges; said intensive distribution structure comprises four tube sections 201, 202, 203 and 204 which are bended and connected together.

The electric grilling device with partial high-temperature heating function of the present invention, it bends the electric heating tube 20 into a shape with one intensive distribution structure, thus the surface of the grilling plate where corresponds to the intensive distribution structure is inevitably the high-temperature region 12, it is because the distribution of the electric heating tube is intenser in that position, after energizing, the electric heating tube (tube sections 201, 202, 203 and 204) will emit more heat, more heat will be transmitted and stored on the grilling plate of said region than other regions, so the temperature of said region will be higher than other regions. The present invention improves the frequently-used existing frame shape which can realize equal distribution, that is to form a protruding portion 21 by inward and integrative bending of one of the frame edges, thus, the four tube bodies of the electric heating tube (tube sections 201, 202, 203 and 204) will close to each other, so the electric heating tube will be an intensive distribution structure compared to other regions. Certainly, the intensive distribution structure of the electric heating tube can be other shapes, a typical design is the wave shape, since the electric heating tube is bended into wave shape, so the tube bodies of the electric heating tube of the wave shape region will be closer, the distribution of the electric heating tube is more intenser than other regions, certainly, other shapes can be used for realizing the intense distribution of the electric heating tube. The position of the intensive distribution structure of the electric heating tube is depended on the position of the high-temperature region of the surface of the grilling plate, in the present embodiment, the high-temperature region is disposed on a side end of the grilling plate, so the intensive distribution structure of the electric heating tube is correspondingly disposed on said side end, and so forth. There is one intensive distribution structure in the present embodiment, certainly, it can be more than one intensive distribution structures, it depends on the requirement of the high-temperature region, when the grilling plate only needs only one high-temperature region, the electric heating tube is bended into a shape with one intensive distribution structure, when the grilling plate needs two high-temperature regions, the electric heating tube is bended into a shape with two intensive distribution structures, and so forth.

The electric grilling device with partial high-temperature heating function of the present invention, it not only improves the structure of the electric heating tube, but also thickens the plate body 13 of the grilling plate 10 where corresponds to the high-temperature region 12, the heating effect of the food will be better in the high-temperature, since the thickness of the plate body of the grilling plate of said region is thickened, so it will be helpful for the heat storage of the grilling plate, the temperature of the surface of the grilling plate will be raised further more.

Although the present invention has been described with reference to the preferred embodiments thereof for carrying out the invention, it is apparent to those skilled in the art that a variety of modifications and changes may be made without departing from the scope of the present invention which is intended to be defined by the appended claims.

### INDUSTRIAL APPLICABILITY

The electric grilling device with partial high-temperature heating function of the present invention, it achieves the partial high-temperature function of the grilling plate, thus it satisfies the different temperature requirements of grilling different food, it not only fully and reasonably utilizes the energy, but also overcomes the shortage of the conventional electric grilling plate wherein the temperature of the grilling plate is relative low and so the grilling effect is affected, the structure of the device is simple, it is convenient to be operated and has a good industrial applicability.

1. An electric grilling device with partial high-temperature heating function, comprising a grilling plate and an electric heating tube installed on the bottom of said grilling plate, wherein: the electric heating tube is bended into a shape with at least one intensive distribution structure, the surface of said grilling plate where corresponds to the intensive distribution structure of said electric heating tube is defined as high-temperature region.

2. The electric grilling device with partial high-temperature heating function according to claim 1, wherein the bottom of said grilling plate has an embedding groove corresponds to the bending shape of said electric heating tube, said electric heating tube is installed in said embedding groove of the bottom of said grilling plate correspondingly.

3. The electric grilling device with partial high-temperature heating function according to claim 2, said high-temperature region of the surface of the grilling plate is disposed on a side portion of the surface of said grilling plate.

4. The electric grilling device with partial high-temperature heating function according to claim 1, the intensive distribution structure of said electric heating tube is a wave shape formed by the bending of said electric heating tube.

5. The electric grilling device with partial high-temperature heating function according to claim 1, said electric heating tube is bended into a frame shape, its intensive distribution structure is a protruding portion formed by the inward and integrative bending of one of frame edges.

6. The electric grilling device with partial high-temperature heating function according to claim 1, wherein said grilling plate where corresponds to said high-temperature region is a thickening structure.

7. An electric grilling device with partial high-temperature heating function, comprising a grilling plate and an electric heating element installed on said grilling plate; wherein the surface of said grilling plate has a first heating region and a second heating region, said electric heating element transmits more heat to said second heating region than to said first heating region, so the heating temperature of said second heating region is higher than that of first heating region.

8. The electric grilling device with partial high-temperature heating function according to claim 7, wherein said electric heating element is an electric heating tube, a second distribution structure of said electric heating tube corresponds to said second heating region is intenser than a first distribution structure of said electric heating tube corresponds to said first heating region.

9. The electric grilling device with partial high-temperature heating function according to claim 8, said second distribution structure of said electric heating tube is a wave shape bended by said electric heating tube.

10. The electric grilling device with partial high-temperature heating function according to claim 7, said grilling plate where corresponds to said second heating region is thicker than said first heating region.

11. The electric grilling device with partial high-temperature heating function according to claim 2, wherein said grilling plate where corresponds to said high-temperature region is a thickening structure.

12. The electric grilling device with partial high-temperature heating function according to claim 3, wherein said grilling plate where corresponds to said high-temperature region is a thickening structure.

13. The electric grilling device with partial high-temperature heating function according to claim 4, wherein said grilling plate where corresponds to said high-temperature region is a thickening structure.

14. The electric grilling device with partial high-temperature heating function according to claim 5, wherein said grilling plate where corresponds to said high-temperature region is a thickening structure.

15. The electric grilling device with partial high-temperature heating function according to claim 8, said grilling plate where corresponds to said second heating region is thicker than said first heating region.

16. The electric grilling device with partial high-temperature heating function according to claim 9, said grilling plate where corresponds to said second heating region is thicker than said first heating region.
